(19) United States
(12) Patent Application Publication
(10) Pub. No.: US 2024/0235101 A1
(43) Pub. Date: Jul. 11, 2024

(54) WATERPROOF CONNECTOR

(71) Applicant: Japan Aviation Electronics Industry, Limited, Tokyo (JP)

(72) Inventors: Takuo SASAKI, Tokyo (JP); Yuji HAMAOKA, Tokyo (JP); Masafumi KODERA, Tokyo (JP)

(21) Appl. No.: 18/610,645

(22) Filed: Mar. 20, 2024

Related U.S. Application Data
(63) Continuation of application No. PCT/JP2022/034533, filed on Sep. 15, 2022.

(30) Foreign Application Priority Data
Nov. 1, 2021 (JP) 2021-178588

(51) Int. Cl. H01R 13/52; H01R 31/06

(52) U.S. Cl. CPC H01R 13/52; H01R 31/06

(57) ABSTRACT

A waterproof connector includes one or more terminal members made of a conductive material and a housing retaining the terminal member and made of an insulating resin, the terminal member having a first connection portion to be connected to the first connection object, a second connection portion to be connected to the second connection object, and a retained portion disposed between the first connection object and the second connection object and retained by the housing, the retained portion having at least one waterproof shaped portion disposed on an outer peripheral surface of the retained portion and spike portions disposed on opposite sides of the waterproof shaped portion across the waterproof shaped portion in a longitudinal direction directed from the first connection portion toward the second connection portion.

### BACKGROUND OF THE INVENTION

The present invention relates to a waterproof connector, particularly to a waterproof connector for electrically connecting a first connection object and a second connection object to each other.

In recent years, there is a strong demand for a waterproof function in various electronic and electrical devices, and accordingly, waterproof connectors having waterproof properties have been under development as connectors to be used in those devices.

As a waterproof connector of this type, for example, JP 2016-219217 A discloses a waterproof connector in which a terminal fitting 3 is fixed to a conductor 2 that is exposed from a coated electric wire 1, and a fixing portion between the conductor 2 and the terminal fitting 3 is covered by a housing 4 that is made of a resin material as illustrated in FIG. 24.

The terminal fitting 3 has a substantially circular cylindrical shape and is provided with a through hole 5 penetrating the terminal fitting 3 in a direction intersecting the longitudinal direction of the terminal fitting 3, and two circumferential grooves 6 are formed in the outer circumferential surface of the terminal fitting 3 to extend in the circumferential direction of the terminal fitting 3.

When the housing 4 is formed, a molten resin material is poured into the through hole 5 and the two circumferential grooves 6 of the terminal fitting 3 and is thereafter cooled, whereby the resin material is solidified in the through hole 5 and the two circumferential grooves 6 to form a columnar body 7 and two annular bodies 8.

In general, a metal material forming the terminal fitting 3 and the resin material forming the housing 4 are different from each other in thermal expansion coefficient and thermal deformation amount derived from a temperature change. Meanwhile, since the columnar body 7 is present in the through hole 5, the terminal fitting 3 and the housing 4 are fixed to each other at the position of the columnar body 7. Hence, when the resin material is cooled to shrink in the process of forming the housing 4, the two annular bodies 8 are pressed against inner walls of the two circumferential grooves 6 of the terminal fitting 3 in the longitudinal direction of the terminal fitting 3 to thereby form seal surfaces. Owing to the seal surfaces, a waterproof effect can be obtained.

However, when a thermal shock derived from an ambient temperature change is repeatedly applied, the resin forming the housing 4 is gradually distorted; even though the terminal fitting 3 and the housing 4 are fixed to each other at the position of the columnar body 7, the contact pressure of the annular bodies 8 of the housing 4 to the inner walls of the circumferential grooves 6 of the terminal fitting 3 decreases, whereby the waterproof effect may be lowered.

### SUMMARY OF THE INVENTION

The present invention has been made to solve the conventional problem as above and aims at providing a waterproof connector having an excellent waterproof effect.

The waterproof connector according to the invention is a waterproof connector for electrically connecting a first connection object and a second connection object to each other, the waterproof connector comprising:
one or more terminal members made of a conductive material; and
a housing retaining the terminal member and made of an insulating resin,
wherein the terminal member includes a first connection portion to be connected to the first connection object, a second connection portion to be connected to the second connection object, and a retained portion that is disposed between the first connection object and the second connection object and that is retained by the housing,
the retained portion includes at least one waterproof shaped portion that is disposed on an outer peripheral surface of the retained portion, and spike portions that are disposed on opposite sides of the waterproof shaped portion across the waterproof shaped portion in a longitudinal direction directed from the first connection portion toward the second connection portion,
the waterproof shaped portion is disposed over an entire circumference of the outer peripheral surface of the retained portion and has a predetermined surface roughness,
the spike portions are each constituted of a structure having a dimension larger than the predetermined surface roughness in a direction perpendicular to the outer peripheral surface of the retained portion, and
a surface of the retained portion is entirely covered by the insulating resin.

### BRIEF DESCRIPTION OF THE DRAWINGS

FIG. 1 is a perspective view showing a waterproof connector according to Embodiment 1 of the present invention.

FIG. 2 is a perspective view showing a terminal member used in the waterproof connector according to Embodiment 1.

FIG. 3 is a transparent view showing the waterproof connector according to Embodiment 1.

FIG. 4 is a cross-sectional side view showing the waterproof connector according to Embodiment 1.

FIG. 5 is an enlarged view of a main part of FIG. 4.

FIG. 6 is a partial plan view showing a terminal member used in a waterproof connector according to Modification 1 of Embodiment 1.

FIG. 7 is a partial plan view showing a terminal member used in a waterproof connector according to Modification 2 of Embodiment 1.

FIG. 8 is a perspective view showing a terminal member used in a waterproof connector according to Modification 3 of Embodiment 1.

FIG. 9 is a perspective view showing a terminal member used in a waterproof connector according to Modification 4 of Embodiment 1.

FIG. 10 is an enlarged partial cross-sectional view of the waterproof connector according to Modification 4 of Embodiment 1.

FIG. 11 is a perspective view showing a terminal member used in a waterproof connector according to Modification 5 of Embodiment 1.

FIG. 12 is a perspective view showing a terminal member used in a waterproof connector according to Modification 6 of Embodiment 1.

FIG. 13 is a perspective view showing a terminal member used in a waterproof connector according to Modification 7 of Embodiment 1.

FIG. 14 is an enlarged partial cross-sectional view of the waterproof connector according to Modification 7 of Embodiment 1.

FIG. 15 is a perspective view showing a terminal member used in a waterproof connector according to Modification 8 of Embodiment 1.

FIG. 16 is a perspective view showing a terminal member used in a waterproof connector according to Modification 9 of Embodiment 1.

FIG. 17 is a perspective view showing a waterproof connector according to Embodiment 2.

FIG. 18 is a perspective view showing a terminal member used in the waterproof connector according to Embodiment 2.

FIG. 19 is a transparent view showing the waterproof connector according to Embodiment 2.

FIG. 20 is a perspective view showing a terminal member used in a waterproof connector according to Modification 1 of Embodiment 2.

FIG. 21 is a perspective view showing a terminal member used in a waterproof connector according to Modification 2 of Embodiment 2.

FIG. 22 is a perspective view showing a terminal member used in a waterproof connector according to Modification 3 of Embodiment 2.

FIG. 23 is a perspective view showing a terminal member used in a waterproof connector according to Modification 4 of Embodiment 2.

FIG. 24 is a cross-sectional view of a conventional waterproof connector.

### DETAILED DESCRIPTION OF THE INVENTION

Embodiments of the present invention are described below based on the accompanying drawings.

### Embodiment 1

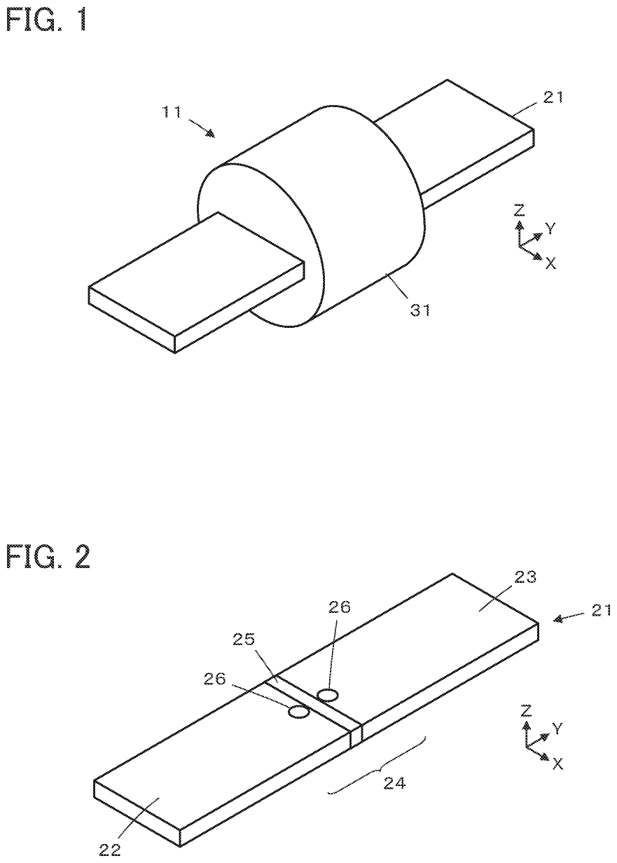

FIG. 1 shows a waterproof connector 11 according to Embodiment 1. The waterproof connector 11 includes a terminal member 21, and a housing 31 retaining the terminal member 21. The terminal member 21 is made of a metal material having conductivity, and the housing 31 is made of an insulating resin.

As shown in FIG. 2, the terminal member 21 has a narrow, flat plate shape extending along a longitudinal direction. The terminal member 21 includes a first connection portion 22 situated at one end in the longitudinal direction, a second connection portion 23 situated at the other end in the longitudinal direction, and a retained portion 24 situated between the first connection portion 22 and the second connection portion 23.

For convenience, the terminal member 21 of flat plate shape is defined to extend along an XY plane, the direction from the first connection portion 22 toward the second connection portion 23 along the longitudinal direction of the terminal member 21 is called “+Y direction,” and the thickness direction of the terminal member 21 that is perpendicular to an XY plane is called “Z direction.”

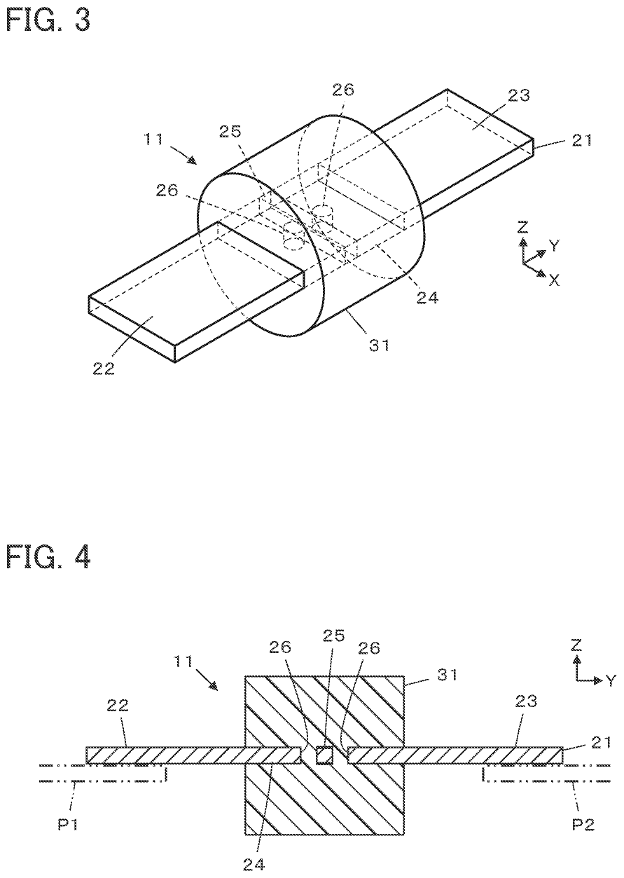

As shown in FIG. 3, the retained portion 24 of the terminal member 21 is embedded in the housing 31, the first connection portion 22 is situated on the −Y direction side of the retained portion 24 and exposed from the housing 31, and the second connection portion 23 is situated on the +Y direction side of the retained portion 24 and exposed from the housing 31. The first connection portion 22 and the second connection portion 23 are to be respectively connected to a first connection object P1 and a second connection object P2 described later.

As shown in FIGS. 2 and 3, the retained portion 24 of the terminal member 21 is provided with a band-like waterproof shaped portion 25 extending along an entire circumference of an outer peripheral surface of the retained portion 24 so as to surround the retained portion 24 in an XZ plane. The waterproof shaped portion 25 is situated at a substantially center part of the terminal member 21 in the Y direction, has a constant Y directional width, and is formed of a roughened surface having a predetermined surface roughness that is rougher than a surface of the remaining part of the terminal member 21 excluding the waterproof shaped portion 25. The predetermined surface roughness improves adhesion between the waterproof shaped portion 25 and the insulating resin when the retained portion 24 of the terminal member 21 is integrally formed in the housing 31.

The surface roughness can be evaluated based on the “arithmetic mean height Sa,” i.e., a surface roughness parameter defined in International Standard ISO-25178, for example. The arithmetic mean height Sa represents an average absolute value of height differences at respective points with respect to an average surface of the surface. The surface roughness can be also evaluated based on the “maximum height Sz” similarly defined in International Standard ISO-25178. The maximum height Sz represents a distance from the highest point to the lowest point of the surface.

The waterproof shaped portion 25 may have a roughened surface in which fine dents and projections are randomly disposed or a roughened surface in which fine dents and/or fine projections are regularly or discretely disposed. Based on an average value or a maximum value of height differences between dents and projections in a region having a predetermined area in the roughened surface, the surface roughness of the waterproof shaped portion 25 can be also evaluated.

In addition, in the retained portion 24 of the terminal member 21, through holes 26 are separately disposed on opposite sides of the waterproof shaped portion 25 across the waterproof shaped portion 25 in the Y direction, i.e., the longitudinal direction of the terminal member 21, and penetrate the terminal member 21 in the Z direction. The through holes 26 are adjacent to the waterproof shaped portion 25 in the Y direction. The through holes 26 each form a structure having a dimension larger than the predetermined surface roughness of the waterproof shaped portion 25 in the direction perpendicular to the outer peripheral surface of the retained portion 24, i.e., in the Z direction, and constitute a “spike portion” in the invention. Since penetrating the terminal member 21 in the Z direction, the through holes 26 have a dimension equivalent to the thickness of the terminal member 21 in the Z direction.

The spike portions constituted of the through holes 26 maintain the adhesion between the waterproof shaped portion 25 and the insulating resin forming the housing 31, because, when the retained portion 24 of the terminal member 21 is integrally formed in the housing 31, part of the molten insulating resin is poured into the structures constituting the spike portions and is thereafter cooled to be solidified.

The surface of the retained portion 24 including the waterproof shaped portion 25 and the through holes 26 as described above is entirely covered by the insulating resin forming the housing 31.

The retained portion 24 of the terminal member 21 is integrally formed in the housing 31, and the surface of the retained portion 24 hence adheres to the insulating resin forming the housing 31, but due to the difference in thermal expansion coefficient between the metal material forming the terminal member 21 and the resin material forming the housing 31, shear force may be generated at an interface between the retained portion 24 and the housing 31 when a thermal shock derived from an ambient temperature change is repeatedly applied. However, since the spike portions constituted of the through holes 26 separately disposed on the opposite sides of the waterproof shaped portion 25 are filled with part of the insulating resin forming the housing 31, it is possible to avoid a situation where fine dents and projections of the roughened surface constituting the waterproof shaped portion 25 are broken by the shear force, and the housing 31 is shifted along the surface of the waterproof shaped portion 25 and comes off the waterproof shaped portion 25.

The structure constituting the spike portion has a dimension larger than the predetermined surface roughness of the waterproof shaped portion 25 in the direction perpendicular to the outer peripheral surface of the retained portion 24, i.e., in the Z direction.

In addition, the shape of the through hole 26 as viewed from the Z direction is not particularly limited and may be, for example, circular, oval, or polygonal.

As shown in FIG. 4, when the retained portion 24 of the terminal member 21 is integrally formed in the housing 31, part of the molten insulating resin comes into contact with the surface of the waterproof shaped portion 25 of the retained portion 24 and is poured into the through holes 26 separately disposed on the opposite sides of the waterproof shaped portion 25, thereafter cooled and solidified.

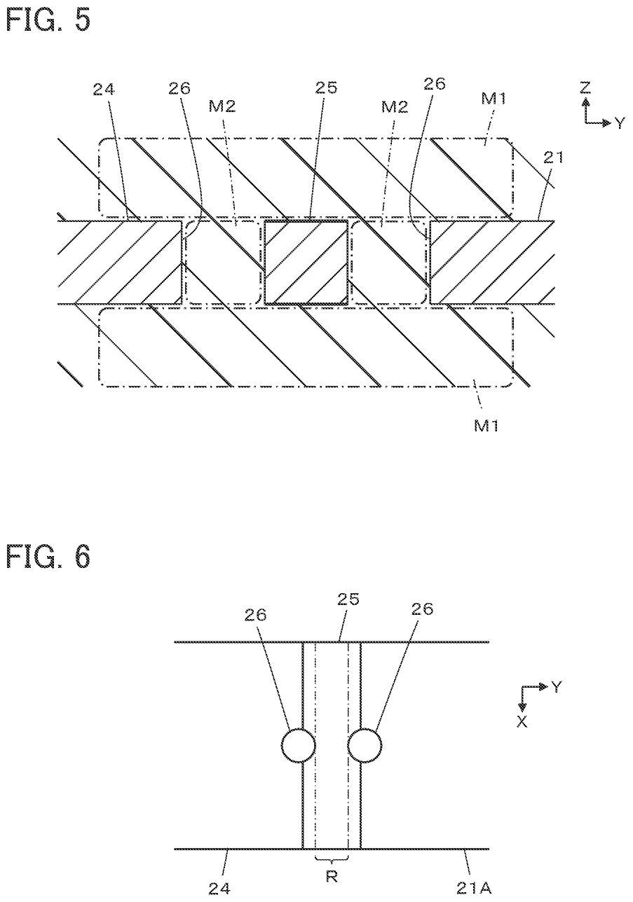

Accordingly, as shown in FIG. 5, a resin part M1 situated on the +Z direction side of the retained portion 24 and a resin part M1 situated on the −Z direction side of the retained portion 24 are jointed to each other by resin parts M2 filling the through holes 26.

Moreover, when the molten insulating resin is cooled to be solidified, the insulating resin undergoes shrinkage, and hence the resin part M1 situated on the +Z direction side of the retained portion 24 and the resin part M1 situated on the −Z direction side of the retained portion 24 are pulled toward each other in the Z direction via the resin parts M2 filling the through holes 26. As a result, the waterproof shaped portion 25 situated between the pair of through holes 26 and the resin parts M1 separately situated on the +Z direction side and the −Z direction side of the waterproof shaped portion 25 have increased adhesion therebetween.

Therefore, even if a thermal shock derived from an ambient temperature change is repeatedly applied, the adhesion between the waterproof shaped portion 25 of the retained portion 24 of the terminal member 21 and the insulating resin forming the housing 31 is maintained, and an excellent waterproof effect can be exhibited for a long period of time.

In addition, since the through holes 26 are separately formed on the opposite sides of the waterproof shaped portion 25 in the Y direction, when a thermal shock is applied, force acting on the fine dents and projections of the roughened surface constituting the waterproof shaped portion 25 is not biased to either one of the +Y direction and the −Y direction, whereby the adhesion between the waterproof shaped portion 25 and the insulating resin is improved.

When the waterproof connector 11 is used, the first connection object P1 is connected to the first connection portion 22 of the terminal member 21 that is exposed from the housing 31, and the second connection object P2 is connected to the second connection portion 23 of the terminal member 21 that is exposed from the housing 31 as shown in FIG. 4. The first connection object Pl and the second connection object P2 are electrically connected to each other via the waterproof connector 11.

The housing 31 can be also configured to be attached to a casing of a device including the first connection object Pl or the second connection object P2.

Alternatively, while the housing 31 is not attached to a casing of a device, the waterproof connector 11 can be used as a linking connector for the first connecting object P1 and the second connection object P2.

Moreover, the waterproof connector 11 may be configured such that the housing 31 includes a counter connector accommodation portion for accommodating part of a counter connector (not shown), and by fitting the waterproof connect 11 to the counter connector, the first connection portion 22 or the second connection portion 23 of the terminal member 21 is electrically connected to a connection terminal of the counter connector.

It should be noted that the through holes 26 as the structures constituting the spike portions are adjacent to the waterproof shaped portion 25 in the Y direction but are not necessarily required to be adjacent to the waterproof shaped portion 25; the through holes 26 can be disposed to be distanced from the waterproof shaped portion 25 in the Y direction.

Meanwhile, for the improved adhesion between the waterproof shaped portion 25 and the insulating resin, and for miniaturization of the waterproof connector 11, the through holes 26 are preferably adjacent to the waterproof shaped portion 25.

In addition, the through holes 26 need not necessarily penetrate the terminal member 21 in the Z direction that is perpendicular to the longitudinal direction of the terminal member 21, and it suffices if the through holes 26 penetrate the terminal member 21 in a direction intersecting the longitudinal direction of the terminal member 21.

### Modification 1 of Embodiment 1

In the terminal member 21 in Embodiment 1, as the structures constituting the spike portions, the through holes 26 separately disposed on the opposite sides of the waterproof shaped portion 25 in the Y direction are adjacent to the waterproof shaped portion 25, but this is not the sole case.

FIG. 6 shows a terminal member 21A used in a waterproof connector according to Modification 1 of Embodiment 1. In the retained portion 24 of the terminal member 21A, the through holes 26 are separately disposed on the opposite sides of the waterproof shaped portion 25 in the Y direction, and each through hole 26 is partly overlapping the waterproof shaped portion 25 and entering the region where the waterproof shaped portion 25 is formed, as viewed from the Z direction, i.e., the thickness direction of the terminal member 21A.

Meanwhile, the waterproof shaped portion 25 includes a region R that does not overlap the adjacent through holes 26 in the Y direction, i.e., the longitudinal direction of the terminal member 21A. In other words, the region R is present between the two through holes 26 disposed with a distance therebetween in the Y direction, which region R is formed of the waterproof shaped portion 25 extending over the entire circumference of the outer peripheral surface of the retained portion 24. The region R extends in a band shape over the entire circumference of the outer peripheral surface of the retained portion 24 so as to surround the retained portion 24 in an XZ plane.

When the retained portion 24 of the terminal member 21A is integrally formed in the housing 31, part of the molten insulating resin is poured into the two through holes 26 disposed across the region R in the Y direction, thereafter cooled and solidified; therefore, coming off of the insulating resin from the surface of the retained portion 24, particularly, from the region R constituted of the waterproof shaped portion 25 due to shear force is prevented.

In addition, a resin part situated on the +Z direction side of the retained portion 24 and a resin part situated on the −Z direction side of the retained portion 24 are jointed to each other by resin parts separately filling the through holes 26.

Hence, even when the through holes 26 partly overlap the waterproof shaped portion 25, an excellent waterproof effect can be exhibited owing to the region R.

Similarly, even when the two through holes 26 disposed with a distance therebetween in the Y direction entirely overlap the waterproof shaped portion 25 as viewed from the Z direction, an excellent waterproof effect can be obtained as long as the region R is present between the two through holes 26, which region R is constituted of the waterproof shaped portion 25 extending over the entire circumference of the outer peripheral surface of the retained portion 24.

### Modification 2 of Embodiment 1

While one through hole 26 is disposed on each of the opposite sides of the waterproof shaped portion 25 in the Y direction in the terminal member 21 in Embodiment 1, the number of through holes 26 disposed on each of or one of the opposite sides of the waterproof shaped portion 25 in the Y direction can be two or more.

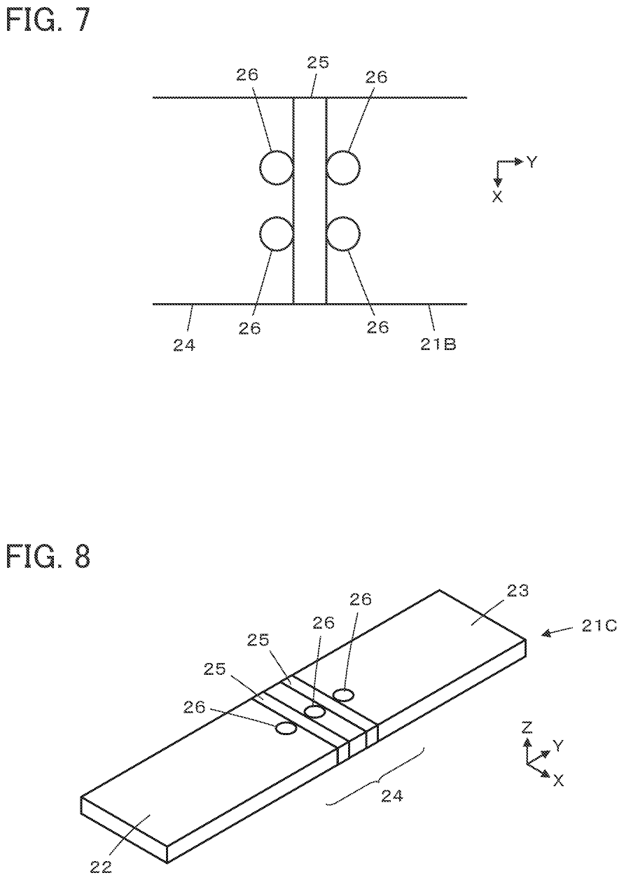

FIG. 7 shows a terminal member 21B used in a waterproof connector according to Modification 2 of Embodiment 1. In the retained portion 24 of the terminal member 21B, two through holes 26 are disposed on each of the opposite sides of the waterproof shaped portion 25 in the Y direction, which two through holes 26 are arranged in the X direction, i.e., the width direction of the terminal member 21B.

When the retained portion 24 of the terminal member 21B is integrally formed in the housing 31, part of the molten insulating resin is poured into each of two through holes 26 disposed on the +Y direction side of the waterproof shaped portion 25 and two through holes 26 disposed on the −Y direction side of the waterproof shaped portion 25, thereafter cooled and solidified. Hence, coming off of the insulating resin from the waterproof shaped portion 25 due to shear force can be more effectively prevented.

In addition, a resin part situated on the +Z direction side of the retained portion 24 and a resin part situated on the −Z direction side of the retained portion 24 are jointed to each other by resin parts filling the four through holes 26 in total, whereby the adhesion between the waterproof shaped portion 25 and the insulating resin is increased.

Therefore, an excellent waterproof effect is obtained.

### Modification 3 of Embodiment 1

While the terminal member 21 in Embodiment 1 includes one waterproof shaped portion 25, and one through hole 26 is disposed on each of the opposite sides of the waterproof shaped portion 25 in the Y direction, a plurality of waterproof shaped portions 25 may be disposed.

FIG. 8 shows a terminal member 21C used in a waterproof connector according to Modification 3 of Embodiment 1. The terminal member 21C includes two waterproof shaped portions 25 and three through holes 26 provided in the retained portion 24.

The two waterproof shaped portions 25 are disposed to be distanced from each other in the Y direction and each extend in a band shape over the entire circumference of the outer peripheral surface of the retained portion 24 so as to surround the retained portion 24 in an XZ plane. The through holes 26 are separately disposed on opposite sides of each of the waterproof shaped portions 25 in the Y direction.

The three through holes 26 are consisted of the through hole 26 disposed on the +Y direction side of and adjacent to, among the two waterproof shaped portions 25, the waterproof shaped portion 25 situated on the +Y direction side, the through hole 26 disposed between and adjacent to the two waterproof shaped portions 25, and the through hole 26 disposed on the −Y direction side of and adjacent to, among the two waterproof shaped portions 25, the waterproof shaped portion 25 situated on the −Y direction side.

When the retained portion 24 of the terminal member 21C is integrally formed in the housing 31, part of the molten insulating resin is poured into each of the three through holes 26, thereafter cooled and solidified. Hence, coming off of the insulating resin from the waterproof shaped portions 25 due to shear force can be effectively prevented.

In addition, a resin part situated on the +Z direction side of the retained portion 24 and a resin part situated on the −Z direction side of the retained portion 24 are jointed to each other by resin parts filling the three through holes 26, whereby the adhesion between each of the two waterproof shaped portions 25 and the insulating resin is increased.

Therefore, a waterproof effect can be improved owing to the two waterproof shaped portions 25.

The terminal member 21C can be also configured such that, similarly, three or more waterproof shaped portions 25 are disposed to be distanced from each other in the Y direction, and the through holes 26 are disposed on the opposite sides of each of the waterproof shaped portions 25 in the Y direction.

### Modification 4 of Embodiment 1

The terminal member 21 in Embodiment 1 includes, as the structures constituting the spike portions, the through holes 26 penetrating the terminal member 21 in the thickness direction, but the structure is not limited to the through hole 26.

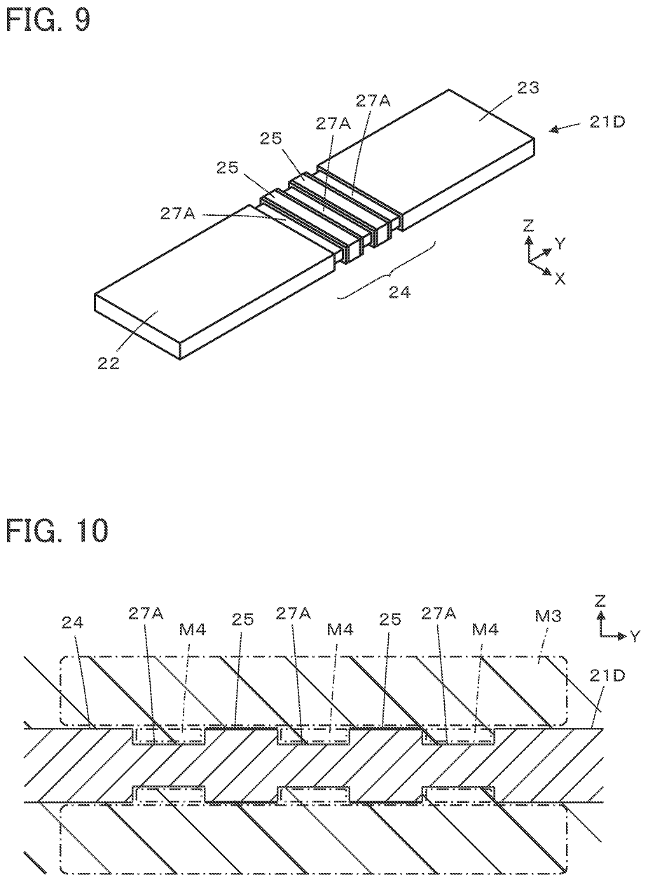

FIG. 9 shows a terminal member 21D used in a waterproof connector according to Modification 4 of Embodiment 1. The terminal member 21D includes two waterproof shaped portions 25 and three recessed portions 27A provided in the retained portion 24.

The waterproof shaped portions 25 each extend in a band shape over the entire circumference of the outer peripheral surface of the retained portion 24 so as to surround the retained portion 24 in an XZ plane and have a predetermined surface roughness rougher than a surface of the remaining part of the terminal member 21D excluding the waterproof shaped portions 25.

The recessed portions 27A are the structures constituting the spike portions and do not penetrate the retained portion 24 but are each shaped to be recessed toward an inside of the retained portion 24 relative to the waterproof shaped portions 25. In particular, each of the recessed portions 27A is formed of a groove continuously surrounding the entire circumference of the outer peripheral surface of the retained portion 24 in an XZ plane and has a depth dimension larger than the predetermined surface roughness of the waterproof shaped portions 25 in the direction perpendicular to the outer peripheral surface of the retained portion 24.

The two waterproof shaped portions 25 and the three recessed portions 27A are alternately arranged in the Y direction, i.e., the longitudinal direction of the terminal member 21D, and the recessed portions 27A are disposed on opposite sides of each of the waterproof shaped portions 25 in the Y direction.

The three recessed portions 27A are consisted of the recessed portion 27A disposed on the +Y direction side of and adjacent to, among the two waterproof shaped portions 25, the waterproof shaped portion 25 situated on the +Y direction side, the recessed portion 27A disposed between and adjacent to the two waterproof shaped portions 25, and the recessed portion 27A disposed on the −Y direction side of and adjacent to, among the two waterproof shaped portions 25, the waterproof shaped portion 25 situated on the −Y direction side.

When the retained portion 24 of the terminal member 21D is integrally formed in the housing 31, as shown in FIG. 10, the molten insulating resin comes into contact with surfaces of the two waterproof shaped portions 25 and is poured into the three recessed portions 27A, thereafter cooled and solidified. A resin part M3 situated on a surface of the retained portion 24 including the two waterproof shaped portions 25 is integrated with resin parts M4 filling the three recessed portions 27A.

Owing to the resin parts M4 separately fitted in the three recessed portions 27A as described above, even if a thermal shock derived from an ambient temperature change is repeatedly applied, coming off of the insulating resin forming the housing 31 from the waterproof shaped portions 25 of the retained portion 24 of the terminal member 21D due to shear force is prevented.

Therefore, an excellent waterproof effect is obtained.

### Modification 5 of Embodiment 1

The terminal member 21D in Modification 4 of Embodiment 1 includes, as the structures constituting the spike portions, the recessed portions 27A each formed of a groove continuously surrounding the entire circumference of the outer peripheral surface of the retained portion 24 in an XZ plane, but the structure is not limited to the recessed portion 27A.

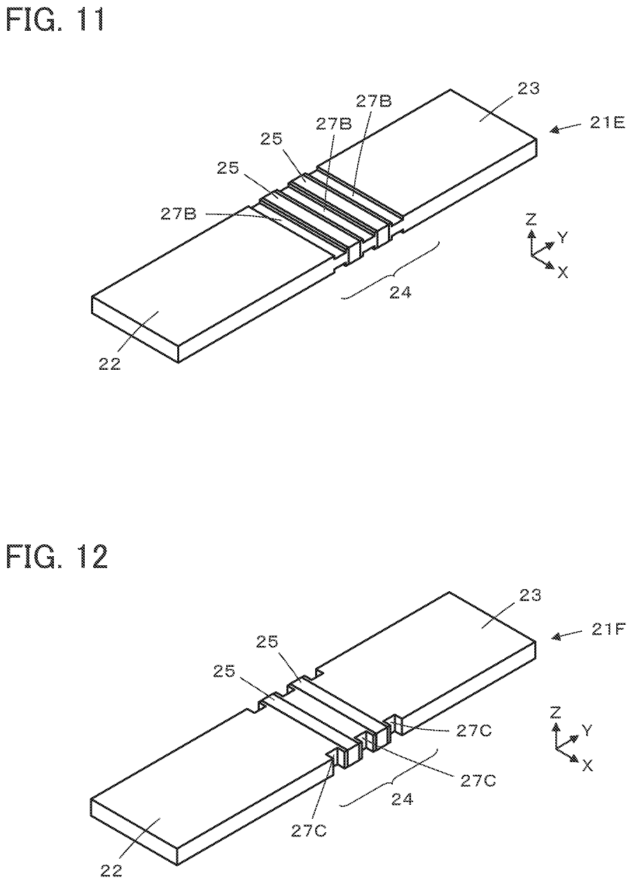

FIG. 11 shows a terminal member 21E used in a waterproof connector according to Modification 5 of Embodiment 1. The terminal member 21E includes three recessed portions 27B, in place of the three recessed portions 27A, in the terminal member 21D in Modification 4.

The recessed portions 27B are the structures constituting the spike portions and include recesses that each linearly extend along the X direction on the +Z directional surface and the −Z directional surface of the retained portion 24 and that are recessed toward an inside of the retained portion 24 relative to the waterproof shaped portions 25. No recess is formed on the +X directional surface and the −X directional surface of the retained portion 24, and a recess on the +Z direction side and a recess on the −Z direction side of the retained portion 24 are disposed to be distanced from each other in a circumferential direction of the outer peripheral surface of the retained portion 24 in an XZ plane. Each of the recesses has a depth dimension larger than the predetermined surface roughness of the waterproof shaped portions 25 in the Z direction.

Even with the recessed portions 27B having the above-described recesses in place of the recessed portions 27A in Modification 4 of Embodiment 1, coming off of the insulating resin forming the housing 31 from the waterproof shaped portions 25 of the retained portion 24 of the terminal member 21E is prevented owing to the resin parts fitted in the recessed portions 27B, whereby an excellent waterproof effect can be exhibited as with Modification 4 of Embodiment 1.

### Modification 6 of Embodiment 1

FIG. 12 shows a terminal member 21F used in a waterproof connector according to Modification 6 of Embodiment 1. The terminal member 21F includes three recessed portions 27C, in place of the three recessed portions 27A, in the terminal member 21D in Modification 4.

The recessed portions 27C are the structures constituting the spike portions and include recesses that each linearly extend along the Z direction on the +X directional surface and the −X directional surface of the retained portion 24 and that are recessed toward an inside of the retained portion 24 relative to the waterproof shaped portions 25. No recess is formed on the +Z directional surface and the −Z directional surface of the retained portion 24, and a recess on the +X direction side and a recess on the −X direction side of the retained portion 24 are disposed to be distanced from each other in a circumferential direction of the outer peripheral surface of the retained portion 24 in an XZ plane. Each of the recesses has a depth dimension larger than the predetermined surface roughness of the waterproof shaped portions 25 in the X direction.

Even with the recessed portions 27C having the above-described recesses in place of the recessed portions 27A in Modification 4 of Embodiment 1, coming off of the insulating resin forming the housing 31 from the waterproof shaped portions 25 of the retained portion 24 of the terminal member 21F is prevented owing to the resin parts fitted in the recessed portions 27C, whereby an excellent waterproof effect can be exhibited as with Modification 4 and Modification 5 of Embodiment 1.

In Modifications 4, 5, and 6 of Embodiment 1 described above, the terminal members 21D, 21E, and 21F each include two waterproof shaped portions 25, but this is not the sole case; the terminal members 21D, 21E, and 21F may be configured to each include one waterproof shaped portion 25 or three or more waterproof shaped portions 25 and be respectively provided with the recessed portions 27A, 27B, and 27C disposed on opposite sides of each waterproof shaped portion 25 in the Y direction.

### Modification 7 of Embodiment 1

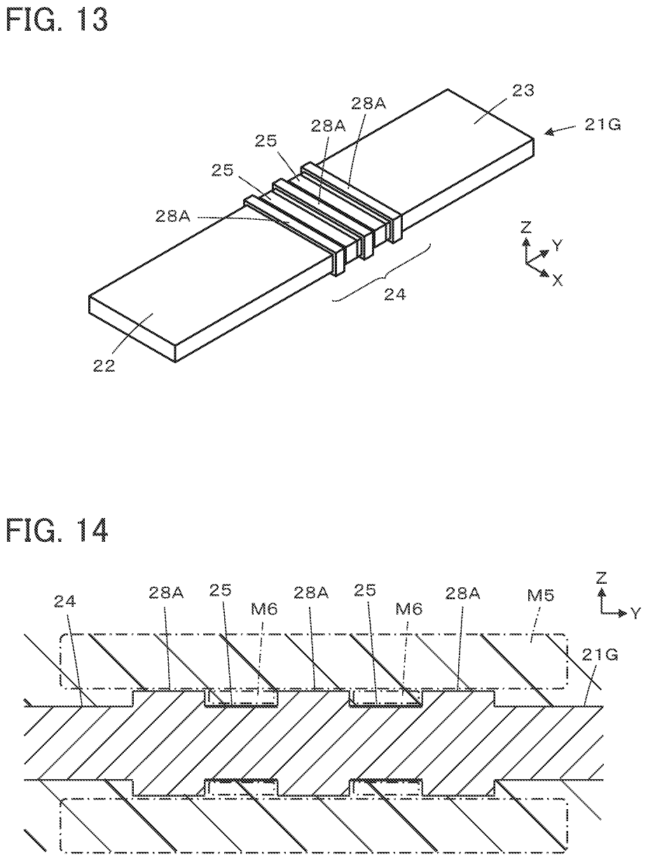

FIG. 13 shows a terminal member 21G used in a waterproof connector according to Modification 7 of Embodiment 1. The terminal member 21G includes two waterproof shaped portions 25 and three protrusion portions 28A provided in the retained portion 24.

The waterproof shaped portions 25 each extend in a band shape over the entire circumference of the outer peripheral surface of the retained portion 24 so as to surround the retained portion 24 in an XZ plane and have a predetermined surface roughness rougher than a surface of the remaining part of the terminal member 21G excluding the waterproof shaped portions 25.

The protrusion portions 28A are the structures constituting the spike portions and are each shaped to protrude toward an outside of the retained portion 24 relative to the waterproof shaped portions 25. In particular, each of the protrusion portions 28A is formed of a protrusion continuously surrounding the entire circumference of the outer peripheral surface of the retained portion 24 in an XZ plane and has a height dimension larger than the predetermined surface roughness of the waterproof shaped portions 25 in the direction perpendicular to the outer peripheral surface of the retained portion 24.

The two waterproof shaped portions 25 and the three protrusion portions 28A are alternately arranged in the Y direction, i.e., the longitudinal direction of the terminal member 21G, and the protrusion portions 28A are disposed on opposite sides of each of the waterproof shaped portions 25 in the Y direction.

The three protrusion portions 28A are consisted of the protrusion portion 28A disposed on the +Y direction side of and adjacent to, among the two waterproof shaped portions 25, the waterproof shaped portion 25 situated on the +Y direction side, the protrusion portion 28A disposed between and adjacent to the two waterproof shaped portions 25, and the protrusion portion 28A disposed on the −Y direction side of and adjacent to, among the two waterproof shaped portions 25, the waterproof shaped portion 25 situated on the −Y direction side.

Since the protrusion portions 28A are disposed on opposite sides of each waterproof shaped portion 25 in the Y direction, on a surface of the waterproof shaped portion 25, a recessed portion is formed of the surface of the waterproof shaped portion 25 and lateral surfaces of the protrusion portions 28A separately disposed on the opposite sides of the waterproof shaped portion 25.

When the retained portion 24 of the terminal member 21G is integrally formed in the housing 31, as shown in FIG. 14, the molten insulating resin comes into contact with surfaces of the three protrusion portions 28A and is poured into recessed portions separately formed on surfaces of the waterproof shaped portions 25, thereafter cooled and solidified. A resin part M5 situated on the surfaces of the three protrusion portions 28A is integrated with resin parts M6 filling the recessed portions formed on the surfaces of the waterproof protrusion portions 25.

Owing to the resin parts M6 separately fitted in the recessed portions formed on the surfaces of the two waterproof shaped portions 25 as described above, even if a thermal shock derived from an ambient temperature change is repeatedly applied, coming off of the insulating resin forming the housing 31 from the waterproof shaped portions 25 of the retained portion 24 of the terminal member 21G due to shear force is prevented.

Therefore, an excellent waterproof effect is obtained.

### Modification 8 of Embodiment 1

The terminal member 21G in Modification 7 of Embodiment 1 includes, as the structures constituting the spike portions, the protrusion portions 28A each formed of a protrusion continuously surrounding the entire circumference of the outer peripheral surface of the retained portion 24 in an XZ plane, but the structure is not limited to the protrusion portion 28A.

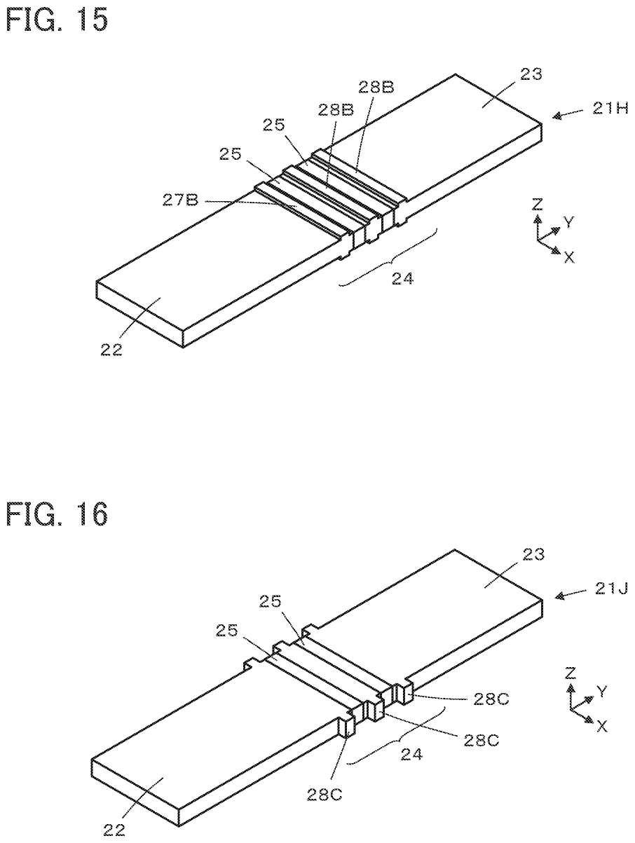

FIG. 15 shows a terminal member 21H used in a waterproof connector according to Modification 8 of Embodiment 1. The terminal member 21H includes three protrusion portions 28B, in place of the three protrusion portions 28A, in the terminal member 21G in Modification 7.

The protrusion portions 28B are the structures constituting the spike portions and include protrusions that each linearly extend along the X direction on the +Z directional surface and the −Z directional surface of the retained portion 24 and that protrude toward an outside of the retained portion 24 relative to the waterproof shaped portions 25. No protrusion is formed on the +X directional surface and the −X directional surface of the retained portion 24, and a protrusion on the +Z direction side and a protrusion on the −Z direction side of the retained portion 24 are disposed to be distanced from each other in a circumferential direction of the outer peripheral surface of the retained portion 24 in an XZ plane. Each of the protrusions has a height dimension larger than the predetermined surface roughness of the waterproof shaped portions 25 in the Z direction.

Since the protrusion portions 28B are disposed on opposite sides of each waterproof shaped portion 25 in the Y direction, on each of the +Z directional surface and the −Z directional surface of the waterproof shaped portion 25, a recessed portion is formed of the surface of the waterproof shaped portion 25 and lateral surfaces of the protrusion portions 28B separately disposed on the opposite sides of the waterproof shaped portion 25.

Even with the recessed portions 28B having the above-described protrusions in place of the protrusion portions 28A in Modification 7 of Embodiment 1, coming off of the insulating resin forming the housing 31 from the waterproof shaped portions 25 of the retained portion 24 of the terminal member 21H is prevented owing to resin parts separately fitted in the recessed portions formed on the +Z directional surfaces and the −Z directional surfaces of the two waterproof shaped portions 25, whereby an excellent waterproof effect can be exhibited as with Modification 7 of Embodiment 1.

### Modification 9 of Embodiment 1

FIG. 16 shows a terminal member 21J used in a waterproof connector according to Modification 9 of Embodiment 1. The terminal member 21J includes three protrusion portions 28C, in place of the three protrusion portions 28A, in the terminal member 21G in Modification 7.

The protrusion portions 28C are the structures constituting the spike portions and include protrusions that each linearly extend along the Z direction on the +X directional surface and the −X directional surface of the retained portion 24 and that protrude toward an outside of the retained portion 24 relative to the waterproof shaped portions 25. No protrusion is formed on the +Z directional surface and the −Z directional surface of the retained portion 24, and a protrusion on the +X direction side and a protrusion on the −X direction side of the retained portion 24 are disposed to be distanced from each other in a circumferential direction of the outer peripheral surface of the retained portion 24 in an XZ plane. Each of the protrusions has a height dimension larger than the predetermined surface roughness of the waterproof shaped portions 25 in the X direction.

Since the protrusion portions 28C are disposed on opposite sides of each waterproof shaped portion 25 in the Y direction, on each of the +X directional surface and the −X directional surface of the waterproof shaped portion 25, a recessed portion is formed of the surface of the waterproof shaped portion 25 and lateral surfaces of the protrusion portions 28C separately disposed on the opposite sides of the waterproof shaped portion 25.

Even with the protrusion portions 28C having the above-described protrusions in place of the protrusion portions 28A in Modification 7 of Embodiment 1, coming off of the insulating resin forming the housing 31 from the waterproof shaped portions 25 of the retained portion 24 of the terminal member 21J is prevented owing to resin parts separately fitted in the recessed portions formed on the +X directional surfaces and the −X directional surfaces of the two waterproof shaped portions 25, whereby an excellent waterproof effect can be exhibited as with Modification 7 and Modification 8 of Embodiment 1.

In Modifications 7, 8, and 9 of Embodiment 1 described above, the terminal members 21G, 21H, and 21J each include two waterproof shaped portions 25, but this is not the sole case; the terminal members 21G, 21H, and 21J may be configured to each include one waterproof shaped portion 25 or three or more waterproof shaped portions 25 and be respectively provided with the protrusion portions 28A, 28B, and 28C disposed on opposite sides of each waterproof shaped portion 25 in the Y direction.

### Embodiment 2

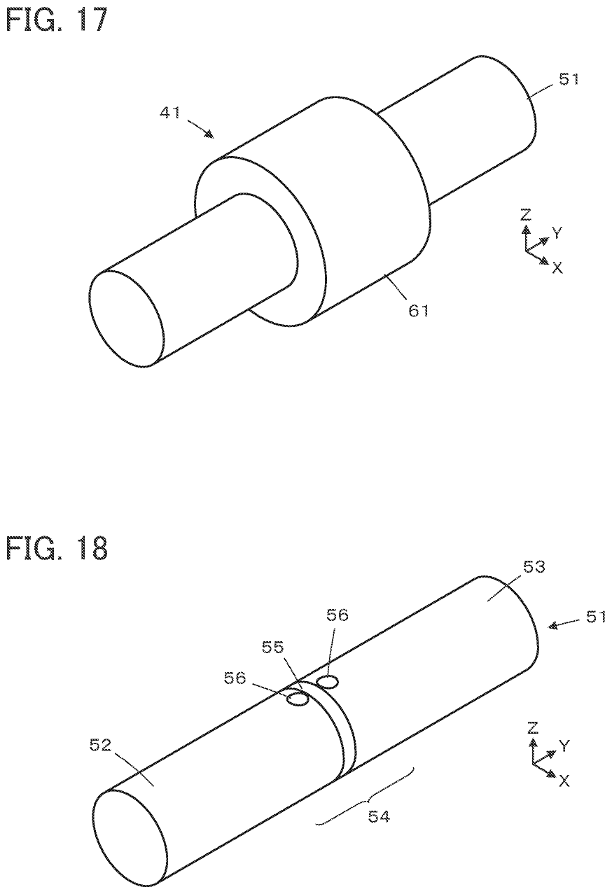

FIG. 17 shows a waterproof connector 41 according to Embodiment 2. The waterproof connector 41 includes a terminal member 51, and a housing 61 retaining the terminal member 51. The terminal member 51 is made of a metal material having conductivity, and the housing 61 is made of an insulating resin.

As shown in FIG. 18, the terminal member 51 has a cylindrical shape extending along a longitudinal direction. The terminal member 51 includes a first connection portion 52 situated at one end in the longitudinal direction, a second connection portion 53 situated at the other end in the longitudinal direction, and a retained portion 54 situated between the first connection portion 52 and the second connection portion 53.

For convenience, the direction from the first connection portion 52 toward the second connection portion 53 along the longitudinal direction of the terminal member 51 of cylindrical shape is called “+Y direction,” and a plane perpendicular to the longitudinal direction of the terminal member 51 is called “XZ plane.”

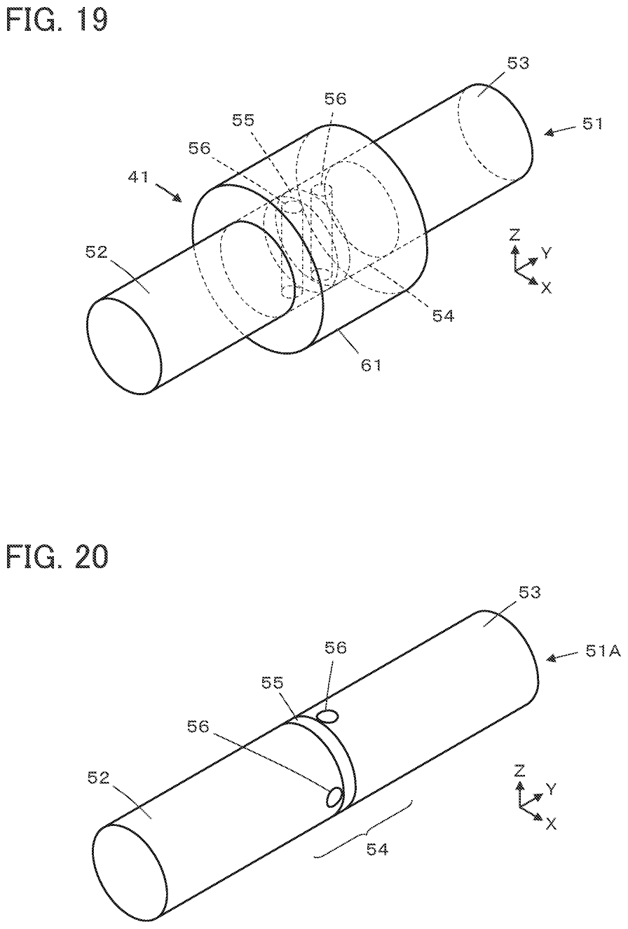

As shown in FIG. 19, the retained portion 54 of the terminal member 51 is embedded in the housing 61, the first connection portion 52 is situated on the −Y direction side of the retained portion 54 and exposed from the housing 61, and the second connection portion 53 is situated on the +Y direction side of the retained portion 54 and exposed from the housing 61.

As shown in FIGS. 18 and 19, the retained portion 54 of the terminal member 51 is provided with a band-like waterproof shaped portion 55 extending along an entire circumference of an outer peripheral surface of the retained portion 54 so as to surround the retained portion 54 in an XZ plane. The waterproof shaped portion 55 is situated at a substantially center part of the terminal member 51 in the Y direction, has a constant Y directional width, and has a predetermined surface roughness that is rougher than a surface of the remaining part of the terminal member 51 excluding the waterproof shaped portion 55, as with the waterproof shaped portion 25 of the terminal member 21 in Embodiment 1.

In addition, in the retained portion 54 of the terminal member 51, through holes 56 are separately disposed on opposite sides of the waterproof shaped portion 55 across the waterproof shaped portion 55 in the Y direction, i.e., the longitudinal direction of the terminal member 51. The through holes 56 penetrate the terminal member 51 of cylindrical shape in parallel to each other in the Z direction. The through holes 56 each form a structure having a dimension larger than the predetermined surface roughness of the waterproof shaped portion 55 in the Z direction and constitute a “spike portion” in the invention.

When the retained portion 54 of the terminal member 51 is integrally formed in the housing 61, part of a molten insulating resin comes into contact with the surface of the retained portion 54 including the waterproof shaped portion 55 and is poured into the through holes 56 separately disposed on the opposite sides of the waterproof shaped portion 55 in the Y direction, thereafter cooled and solidified.

A resin part situated around the retained portion 54 and a resin part filling the through holes 56 are thus jointed to each other.

Moreover, when the molten insulating resin is cooled to be solidified, the insulating resin undergoes shrinkage, and hence a resin part situated on the +Z direction side of the retained portion 54 and a resin part situated on the −Z direction side of the retained portion 54 are pulled toward each other in the Z direction via the resin part filling the through holes 56 extending in the Z direction. As a result, the waterproof shaped portion 55 situated between the two through holes 56, the resin part situated on the +Z direction side of the waterproof shaped portion 55, and the resin part situated on the −Z direction side of the waterproof shaped portion 55 have increased adhesion therebetween.

Hence, even if a thermal shock derived from an ambient temperature change is repeatedly applied, coming off of the insulating resin forming the housing 61 from the waterproof shaped portion 55 of the retained portion 54 of the terminal member 51 due to shear force is prevented, and an excellent waterproof effect can be obtained.

### Modification 1 of Embodiment 2

The terminal member 51 in Embodiment 2 is provided with, as the structures constituting the spike portions, the through holes 56 penetrating the terminal member 51 in the Z direction on opposite sides of the waterproof shaped portion 55 in the Y direction, but the through holes 56 need not extend in parallel to each other.

FIG. 20 shows a terminal member 51A used in a waterproof connector according to Modification 1 of Embodiment 2. In the retained portion 54 of the terminal member 51A, while the through holes 56 are separately disposed on the opposite sides of the waterproof shaped portion 55 in the Y direction, the two through holes 56 do not extend in parallel to each other, but one of the through holes 56 penetrates the terminal member 51A of cylindrical shape in the Z direction, and the other one of the through holes 56 penetrates the terminal member 51A of cylindrical shape in the X direction.

Even if the terminal member 51A has the two through holes 56 penetrating in different directions from each other, when the retained portion 54 of the terminal member 51A is integrally formed in the housing 61, part of the molten insulating resin is poured into each of the two through holes 56, thereafter cooled and solidified. Hence, coming off of the insulating resin from the waterproof shaped portion 55 due to shear force can be effectively prevented.

Moreover, when the molten insulating resin is cooled to be solidified, the insulating resin undergoes shrinkage, and hence in the vicinity of the through hole 56 penetrating the terminal member 51A in the Z direction, a resin part situated on the +Z direction side of the retained portion 54 and a resin part situated on the −Z direction side of the retained portion 54 are pulled toward each other in the Z direction via a resin part filling the through hole 56 extending in the Z direction. Similarly, in the vicinity of the through hole 56 penetrating the terminal member 51A in the X direction, a resin part situated on the +X direction side of the retained portion 54 and a resin part situated on the −X direction side of the retained portion 54 are pulled toward each other in the X direction via a resin part filling the through hole 56 extending in the X direction.

As a result, the waterproof shaped portion 55 situated between the two through holes 56, the resin part situated on the +Z direction side of the waterproof shaped portion 55, and the resin part situated on the −Z direction side of the waterproof shaped portion 55 have increased adhesion therebetween both in the Z direction and in the X direction.

Therefore, a more excellent waterproof effect can be obtained.

It should be noted that the two through holes 56 are not limited to extend in orthogonal directions to each other but may extend in any directions intersecting each other.

### Modification 2 of Embodiment 2

While the terminal member 51 in Embodiment 2 includes one waterproof shaped portion 55, and one through hole 56 is disposed on each of the opposite sides of the waterproof shaped portion 55 in the Y direction, a plurality of waterproof shaped portions 55 may be disposed.

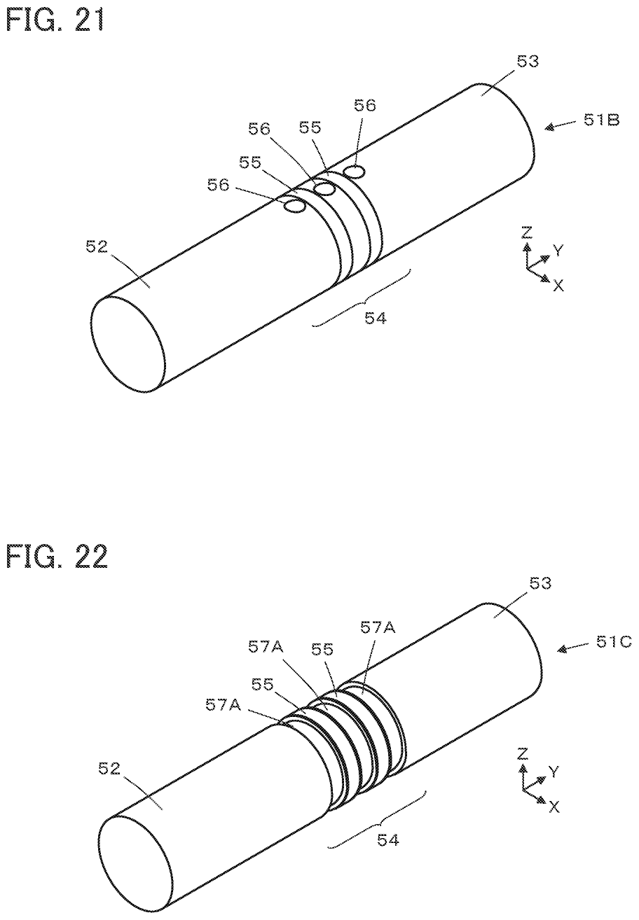

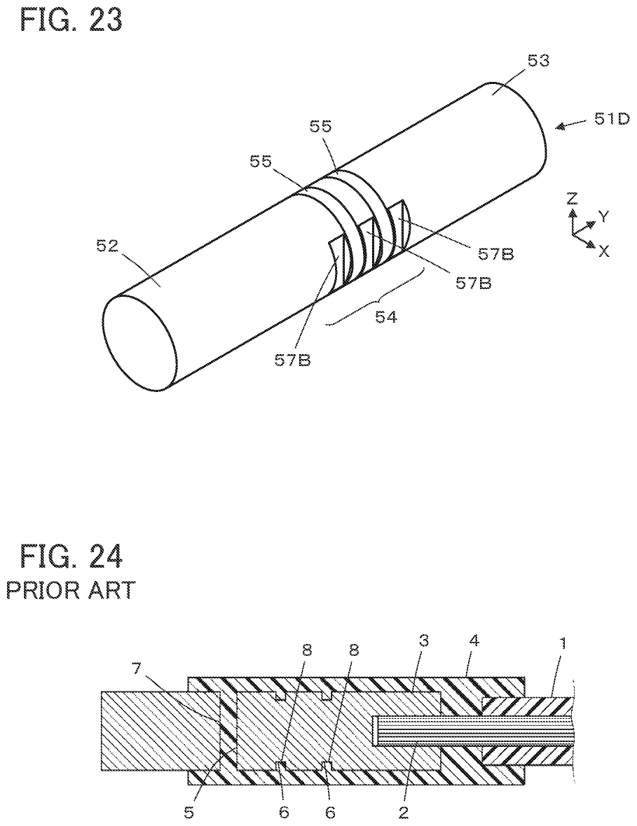

FIG. 21 shows a terminal member 51B used in a waterproof connector according to Modification 2 of Embodiment 2. The terminal member 51B includes two waterproof shaped portions 55 and three through holes 56 provided in the retained portion 54.

The two waterproof shaped portions 55 are disposed to be distanced from each other in the Y direction and each extend in a band shape over the entire circumference of the outer peripheral surface of the retained portion 54 so as to surround the retained portion 54 in an XZ plane. The through holes 56 are separately disposed on opposite sides of each of the waterproof shaped portions 55 in the Y direction.

The three through holes 56 are consisted of the through hole 56 disposed on the +Y direction side of and adjacent to, among the two waterproof shaped portions 55, the waterproof shaped portion 55 situated on the +Y direction side, the through hole 56 disposed between and adjacent to the two waterproof shaped portions 55, and the through hole 56 disposed on the −Y direction side of and adjacent to, among the two waterproof shaped portions 55, the waterproof shaped portion 55 situated on the −Y direction side.

When the retained portion 54 of the terminal member 51B is integrally formed in the housing 61, part of the molten insulating resin is poured into each of the three through holes 56, thereafter cooled and solidified. Hence, coming off of the insulating resin from the waterproof shaped portion 55 due to shear force can be effectively prevented.

In addition, when the molten insulating resin is cooled to be solidified, the insulating resin undergoes shrinkage, and hence a resin part situated on the +Z direction side of the retained portion 54 and a resin part situated on the −Z direction side of the retained portion 54 are pulled toward each other in the Z direction via a resin part filling the three through holes 56 extending in the Z direction. As a result, the adhesion between each of the two waterproof shaped portions 55 and the insulating resin is increased.

Therefore, a waterproof effect can be improved owing to the two waterproof shaped portions 55.

The three through holes 56 may extend along different directions from each other.

Moreover, the terminal member 51B can be also configured such that, similarly, three or more waterproof shaped portions 55 are disposed to be distanced from each other in the Y direction, and the through holes 56 are disposed on the opposite sides of each of the waterproof shaped portions 55 in the Y direction.

### Modification 3 of Embodiment 2

The terminal member 51 in Embodiment 2 includes, as the structures constituting the spike portions, the through holes 56 penetrating the terminal member 51 of cylindrical shape in a radial direction, but the structure is not limited to the through hole 56.

FIG. 22 shows a terminal member 51C used in a waterproof connector according to Modification 3 of Embodiment 2. The terminal member 51C includes two waterproof shaped portions 55 and three recessed portions 57A provided in the retained portion 54.

The waterproof shaped portions 55 each extend in a band shape over the entire circumference of the outer peripheral surface of the retained portion 54 so as to surround the retained portion 54 in an XZ plane and have a predetermined surface roughness rougher than a surface of the remaining part of the terminal member 51C excluding the waterproof shaped portions 55.

The recessed portions 57A are the structures constituting the spike portions and do not penetrate the retained portion 54 but are each shaped to be recessed toward an inside of the retained portion 54 relative to the waterproof shaped portions 55. In particular, each of the recessed portions 57A is formed of a groove continuously surrounding the entire circumference of the outer peripheral surface of the retained portion 54 in an XZ plane and has a depth dimension larger than the predetermined surface roughness of the waterproof shaped portions 55 in the direction perpendicular to the outer peripheral surface of the retained portion 54.

The two waterproof shaped portions 55 and the three recessed portions 57A are alternately arranged in the Y direction, i.e., the longitudinal direction of the terminal member 51C, and the recessed portions 57A are disposed on opposite sides of each of the waterproof shaped portions 55 in the Y direction.

The three recessed portions 57A are consisted of the recessed portion 57A disposed on the +Y direction side of and adjacent to, among the two waterproof shaped portions 55, the waterproof shaped portion 55 situated on the +Y direction side, the recessed portion 57A disposed between and adjacent to the two waterproof shaped portions 55, and the recessed portion 57A disposed on the −Y direction side of and adjacent to, among the two waterproof shaped portions 55, the waterproof shaped portion 55 situated on the −Y direction side.

When the retained portion 54 of the terminal member 51C is integrally formed in the housing 61, the molten insulating resin comes into contact with surfaces of the two waterproof shaped portions 55 and is poured into the three recessed portions 57A, thereafter cooled and solidified. A resin part situated on a surface of the retained portion 54 including the two waterproof shaped portions 55 is integrated with a resin part filling the three recessed portions 57A.

Owing to the resin part fitted in each of the three recessed portions 57A as described above, even if a thermal shock derived from an ambient temperature change is repeatedly applied, coming off of the insulating resin forming the housing 61 from the waterproof shaped portions 55 of the retained portion 54 of the terminal member 51C due to shear force is prevented.

Therefore, an excellent waterproof effect is obtained

### Modification 4 of Embodiment 2

The terminal member 51C in Modification 3 of Embodiment 2 includes, as the structures constituting the spike portions, the recessed portions 57A each formed of a groove continuously surrounding the entire circumference of the outer peripheral surface of the retained portion 54 in an XZ plane, but the structure is not limited to the recessed portion 57A.

FIG. 23 shows a terminal member 51D used in a waterproof connector according to Modification 4 of Embodiment 2. The terminal member 51D includes three recessed portions 57B, in place of the three recessed portions 57A, in the terminal member 51C in Modification 3.

The recessed portions 57B are the structures constituting the spike portions and include recesses that linearly extend along the Z direction on a surface of part, facing in the +X direction, of the retained portion 54 and that are recessed toward an inside of the retained portion 54 relative to the waterproof shaped portions 55. Although not shown in FIG. 23, the recessed portions 57B include recesses that linearly extend along the Z direction also on a surface of part, facing in the −X direction, of the retained portion 54 and that are recessed toward an inside of the retained portion 54 relative to the waterproof shaped portions 55. No recess is formed on surfaces of parts, facing in the +Z direction and the −Z direction, of the retained portion 54, and a recess on the +X direction side and a recess on the −X direction side of the retained portion 54 are disposed to be distanced from each other in a circumferential direction of the outer peripheral surface of the retained portion 54 in an XZ plane. Each of the recesses has a depth dimension larger than the predetermined surface roughness of the waterproof shaped portions 55 in the X direction.

Even with the recessed portions 57B having the above-described recesses in place of the recessed portions 57A in Modification 3 of Embodiment 2, coming off of the insulating resin forming the housing 61 from the waterproof shaped portions 55 of the retained portion 54 of the terminal member 51D is prevented owing to the resin part fitted in the recessed portions 57B, whereby an excellent waterproof effect can be exhibited as with Modification 3 of Embodiment 2.

In Modifications 3 and 4 of Embodiment 2 described above, the terminal members 51C and 51D each include two waterproof shaped portions 55, but this is not the sole case; the terminal members 51C and 51D may be configured to each include one waterproof shaped portion 55 or three or more waterproof shaped portions 55 and be respectively provided with the recessed portions 57A and 57B disposed on opposite sides of each waterproof shaped portion 55 in the Y direction.

In addition, in place of the recessed portions 57A and 57B in Modifications 3 and 4 of Embodiment 2 described above, protrusion portions can be separately disposed on opposite sides of the waterproof shaped portion 55, the protrusion portions protruding toward an outside of the retained portion 54 relative to the waterproof shaped portions 55.

The protrusion portion can be formed of a protrusion continuously surrounding the entire circumference of the outer peripheral surface of the retained portion 54 in an XZ plane or may include a plurality of protrusions disposed with a distance therebetween in the circumferential direction of the outer peripheral surface of the retained portion 54. Meanwhile, these protrusions should have a height dimension larger than the predetermined surface roughness of the waterproof shaped portions 55 in the direction perpendicular to the outer peripheral surface of the retained portion 54.

In Embodiment 1, Modifications 1 to 9 of Embodiment 1, Embodiment 2, and Modifications 1 to 4 of Embodiment 2 described above, the inner peripheral surface of the through hole 26, 56, the inner surface of the recessed portion 27A, 27B, 27C, 57A, 57B, and the outer surface of the protrusion portion 28A, 28B, 28C used as the structure constituting the spike portion can be smooth surfaces smoother than the waterproof shaped portion 25, 55 and can be rough surfaces having a surface roughness rougher than the predetermined surface roughness of the waterproof shaped portion 25, 55.

What is claimed is:

1. A waterproof connector for electrically connecting a first connection object and a second connection object to each other, the waterproof connector comprising:
one or more terminal members made of a conductive material; and
a housing retaining the terminal member and made of an insulating resin,
wherein the terminal member includes a first connection portion to be connected to the first connection object, a second connection portion to be connected to the second connection object, and a retained portion that is disposed between the first connection object and the second connection object and that is retained by the housing,
the retained portion includes at least one waterproof shaped portion that is disposed on an outer peripheral surface of the retained portion, and spike portions that are disposed on opposite sides of the waterproof shaped portion across the waterproof shaped portion in a longitudinal direction directed from the first connection portion toward the second connection portion,
the waterproof shaped portion is disposed over an entire circumference of the outer peripheral surface of the retained portion and has a predetermined surface roughness,
the spike portions are each constituted of a structure having a dimension larger than the predetermined surface roughness in a direction perpendicular to the outer peripheral surface of the retained portion, and
a surface of the retained portion is entirely covered by the insulating resin.

2. The waterproof connector according to claim 1, wherein the retained portion includes two or more of the waterproof shaped portions disposed with a distance therebetween in the longitudinal direction, and the spike portions are disposed on opposite sides of each of the waterproof shaped portions in the longitudinal direction.

3. The waterproof connector according to claim 1, wherein the spike portions are adjacent to the waterproof shaped portion in the longitudinal direction.

4. The waterproof connector according to claim 1, wherein the waterproof shaped portion has a region that does not overlap the spike portions adjacent to the waterproof shaped portion in the longitudinal direction.

5. The waterproof connector according to claim 1, wherein the spike portions include, as the structure, a through hole that penetrates the retained portion in a direction intersecting the longitudinal direction.

6. The waterproof connector according to claim 1, wherein the spike portions include, as the structure, a recessed portion that is recessed toward an inside of the retained portion relative to the waterproof shaped portion.

7. The waterproof connector according to claim 6, wherein the recessed portion is formed of a groove continuously surrounding an entire circumference of the outer peripheral surface of the retained portion.

8. The waterproof connector according to claim 6, wherein the recessed portion includes a plurality of recesses disposed with a distance therebetween in a circumferential direction of the outer peripheral surface of the retained portion.

9. The waterproof connector according to claim 1, wherein the spike portions include, as the structure, a protrusion portion that protrudes toward an outside of the retained portion relative to the waterproof shaped portion.

10. The waterproof connector according to claim 9, wherein the protrusion portion is formed of a protrusion continuously surrounding an entire circumference of the outer peripheral surface of the retained portion.

11. The waterproof connector according to claim 9, wherein the protrusion portion includes a plurality of protrusions disposed with a distance therebetween in a circumferential direction of the outer peripheral surface of the retained portion.
